(19) United States
(12) Patent Application Publication
(10) Pub. No.: US 2026/0259410 A1
(43) Pub. Date: Sep. 3, 2026

(54) Electronic Devices with Lenses and Custom Units

(71) Applicant: Apple Inc., Cupertino, CA (US)

(72) Inventor: Anna V Mirabella, San Francisco, CA (US)

(21) Appl. No.: 18/846,626

(22) PCT Filed: Mar. 22, 2023
(86) PCT No.: PCT/US2023/064820

§ 371 Date: Sep. 12, 2024

Related U.S. Application Data
(60) Provisional application No. 63/326,749, filed on Apr. 1, 2022.

(51) Int. Cl. G02B 27/01; G02C 7/02; G02C 9/04

(52) U.S. Cl. CPC G02B 27/0172; G02C 7/022; G02C 9/04; G02B 2027/011; G02B 2027/0154; G02B 2027/0159; G02B 2027/0185

(57) ABSTRACT

A head-mounted device may include a support structure that supports a display and a fixed lens. Vision correction lenses may be removably coupled to the fixed lenses to help customize the head-mounted device to the vision of a particular user. To reduce the number of prescription lenses needed on hand at a demonstration site, the demonstration site may include multiple head-mounted display units with different virtual image distances for providing different amounts of spherical correction to the displayed image. For example, a baseline unit may accommodate users that do not require a prescription, a myopic unit may accommodate nearsighted users, and a hyperopic unit may accommodate farsighted users. These different head-mounted display units, when combined with the cylindrical correction of a supplemental prescription lens, may be configured to accommodate a greater number of prescriptions with a fewer number of supplemental prescription lenses on hand.

This application claims priority to U.S. provisional patent application No. 63/326,749, filed Apr. 1, 2022, which is hereby incorporated by reference herein in its entirety.

### FIELD

This relates generally to electronic devices, and, more particularly, to electronic devices with displays and lenses.

### BACKGROUND

Electronic devices such as head-mounted devices may have displays for displaying images. The displays may be housed in optical modules. Lenses may be mounted in the optical modules. Using the lenses, a user may view displayed images.

### SUMMARY

A head-mounted device may have optical modules or other support structures with displays that present images to a user's left and right eyes. Each optical module may have a lens support structure that supports a respective display and fixed lens. Vision correction lenses may be removably coupled to the fixed lenses to accommodate a user's vision. During operation, a user may view images on the displays through the vision correction lenses and the fixed lenses from eye boxes.

To reduce the number of prescription lenses needed on hand at a demonstration site, a system may include multiple head-mounted display units with different virtual image distances for providing different amounts of spherical correction to displayed images. For example, a baseline unit may accommodate users that do not require a prescription, a myopic unit may accommodate nearsighted users and/or users with presbyopia, and a hyperopic unit may accommodate farsighted users. These different head-mounted display units, when combined with the cylindrical correction of a supplemental prescription lens, may be configured to accommodate a greater number of prescriptions with a fewer number of supplemental prescription lenses on hand.

### BRIEF DESCRIPTION OF THE DRAWINGS

FIG. 1 is a top view of an illustrative head-mounted device in accordance with an embodiment.

FIG. 2 is a top view of an illustrative head-mounted device with a nominal virtual image distance and an optional prescription lens in accordance with an embodiment.

FIG. 3 is a top view of an illustrative head-mounted device with a shortened virtual image distance for accommodating myopic vision and having an optional prescription lens in accordance with an embodiment.

FIG. 4 is a top view of an illustrative head-mounted device with an increased virtual image distance for accommodating hyperopic vision and having an optional prescription lens in accordance with an embodiment.

FIG. 5 is a graph showing how a larger percentage of a population can be accommodated by using multiple head-mounted devices with different virtual image distances and a given number of optional prescription lenses in accordance with an embodiment.

FIG. 6 is a flow chart of illustrative steps involved in providing a user with a head-mounted device and supplemental prescription lens to accommodate the user's prescription in accordance with an embodiment.

### DETAILED DESCRIPTION

An electronic device such as a head-mounted device may have a head-mounted support structure that supports lenses, displays and other components. During operation, the head-mounted device may display visual content for a user such as virtual reality content or augmented reality content.

The head-mounted support structure may be configured to form a pair of glasses, a pair of goggles, a helmet, or other head-mounted device. Illustrative configurations in which the head-mounted device is a pair of goggles may sometimes be described herein as an example.

The head-mounted support structure may have a front face that faces away from a user's head and may have an opposing rear face that faces the user's head. Optical modules on the rear face may be used to provide images to a user's eyes. Each optical module may have a lens barrel in which a fixed lens is mounted. Optional removable supplemental lenses may be coupled to the optical modules. The supplemental lenses, which may sometimes be referred to as vision correction lenses may be used to correct for a user's vision defects such as nearsightedness, farsightedness, and astigmatism.

Inventory management of prescription lenses for head-mounted devices may be complex due to a wide range of spherical and cylindrical corrections that may be required by different users wishing to test out the head-mounted device in a demonstration setting before purchasing. There may be upwards of fifty thousand different types of prescription lenses available for use with a given head-mounted device.

To reduce the amount of prescription lenses needed on hand at a demonstration site (e.g., a retail store, conference, exposition, channel sale setting, etc.), the demonstration site may include a system of multiple head-mounted devices having different virtual image distances. Changing the virtual image distance (e.g., the distance between the fixed lens and the display) is equivalent to a spherical prescription correction. By combining a head-mounted display unit with an offset virtual image distance with a clip-on or otherwise modular prescription lens, a user's individual prescription may be accommodated without requiring the clip-on prescription lens to exactly match the user's prescription. As such, a fewer number of prescription lenses may be kept on hand in a demonstration site by keeping in stock multiple head-mounted display units with different virtual image distances.

For example, a demonstration site may have on hand a first head-mounted display unit with a first virtual image distance serving as a baseline unit (e.g., for users that do not require prescription correction), a second head-mounted display unit with a second virtual image distance serving as a myopic unit (e.g., for nearsighted users, users with presbyopia, etc.), and a third head-mounted display unit with a third virtual image distance serving as a hyperopic unit (e.g., for farsighted users). If desired, a demonstration site may have head-mounted device units with more than three or fewer than three different virtual image distances. The example of three units with three different virtual image distances is merely illustrative. These different head-mounted display units, when combined with a given number of supplemental (e.g., clip-on or otherwise modular) prescription lenses, may be configured to accommodate a much greater number of prescriptions (e.g., a number greater than the amount of prescription lenses on hand at the store). This allows the retail environment to give demonstrations to a larger percentage of the population while requiring a lower number of supplemental prescription lenses to be kept in stock. If desired, the virtual image distances of the head-mounted device units in a given store may be optimized based on regional or store-specific data (e.g., more myopic units for countries with more myopic users, not requiring a unit for presbyopia if store traffic patterns show a larger percentage of customers are under the age of 40, etc.).

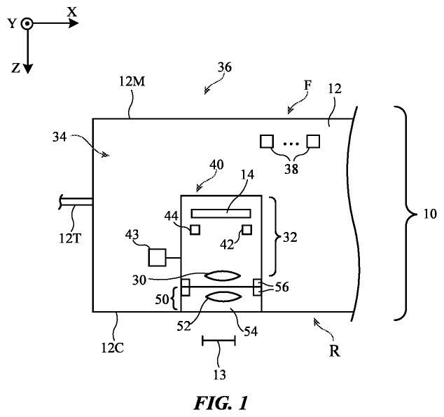

A top view of an illustrative head-mounted device is shown in FIG. 1. As shown in FIG. 1, head-mounted devices such as electronic device 10 may have head-mounted support structures such as housing 12. Housing 12 may include portions (e.g., support structure 12T) to allow device 10 to be worn on a user's head. Support structure 12T may be formed from fabric, polymer, metal, and/or other material. Support structure 12T may form a strap or other head-mounted support structure to help support device 10 on a user's head. A main support structure (e.g., main housing portion 12M) of housing 12 may support electronic components such as display 14. There may be left and right displays 14 in device 10. In the example of FIG. 1, a left display for a user's left eye is shown as an example.

Main housing portion 12M may include housing structures formed from metal, polymer, glass, ceramic, and/or other material. For example, housing portion 12M may have housing walls on front face F and housing walls on adjacent top, bottom, left, and right side faces that are formed from rigid polymer or other rigid support structures and these rigid walls may optionally be covered with electrical components, glass, metal, fabric, leather, or other materials. The walls of housing portion 12M may enclose internal components 38 in interior region 34 of device 10 and may separate interior region 34 from the environment surrounding device 10 (exterior region 36). Internal components 38 may include integrated circuits, actuators, batteries, sensors, control circuitry, and/or other circuits and structures for device 10. These components may include sensors such as image sensors, ambient light sensors, touch sensors, force sensors, orientation sensors (e.g., orientation sensors based on accelerometers, compasses, and/or gyroscopes such as orientation sensors based on inertial measurement units containing some or all of these components), proximity sensors, capacitive sensors, optical sensors, three-dimensional image sensors such as structured light sensors and/or three-dimensional sensors based on stereoscopic pairs of two-dimensional image sensors, gaze tracking sensors, hand sensors, sensors for monitoring the movement and position of accessories such as controllers, microphones for gathering voice commands and measuring ambient noise, temperature sensors, fingerprint sensors and other biometric sensors, and/or other sensing circuitry.

Front face F of housing 12 may face outwardly away from a user's head and face. Opposing rear face R of housing 12 may face the user. Portions of housing 12 (e.g., portions of main housing 12M) on rear face R may form a cover such as cover 12C (sometimes referred to as a curtain). The presence of cover 12C on rear face R may help hide internal housing structures, internal components 38, and other structures in interior region 34 from view by a user.

Device 10 may have left and right optical modules 40. A left optical module and associated left eye box 13 are shown in the left portion of device 10 of FIG. 1. Optical modules 40 support electrical and optical components such as light-emitting components and lenses and may therefore sometimes be referred to as optical assemblies, optical systems, optical component support structures, lens and display support structures, electrical component support structures, or housing structures. Each optical module may include a respective display 14 mounted in a respective support structure 32. Support structures 32, which may sometimes be referred to as lens barrels, lens support structures, optical component support structures, or optical module support structures, may include hollow cylindrical structures with open ends or other supporting structures to house displays 14 and lens components. Support structures 32 may, for example, include a left lens barrel that supports a left display 14 and left lens 30 and a right lens barrel that supports a right display 14 and right lens 30.

Lenses 30 may be fixedly mounted to support structures 32. Additional vision correction lens modules 54 may be fixedly or removably coupled to modules 40 (e.g., to form a left lens that is corrected for the user's left eye vision and a right lens that is corrected for the user's right eye vision).

Vision correction lens modules 54 may each have one or more vision correction lens elements (sometimes referred to as vision correction lenses or lens substrates) mounted in a vision correction lens housing such as housing 50. As shown in FIG. 1, vision correction lenses (lens elements) 52 of lens modules 54 may overlap corresponding fixed lenses 30. During operation, a user may view an image on each display 14 through a respective vision correction lens 52 and a respective overlapped fixed lens 30. Vision correction lenses 52 may be selected to correct for the vision defects (e.g., nearsightedness, farsightedness, and/or astigmatism) of a user.

Each housing 50, which may sometimes be referred to as a lens mount or vision correction lens support structure may be formed from a ring of polymer, metal, and/or other materials. An opening in the center of housing 50 may accommodate lens element 54. One or more magnets 56 or other attachment structures (e.g., press-fit connections, clips, fasteners, etc.) may be mounted in housing 50 and may be mounted in corresponding portions of support structure 32 of module 40 to allow vision correction lens 52 to be removably attached to module 40. This type of arrangement may allow different users to install different vision correction lenses.

Displays 14 may include arrays of pixels or other display devices to produce images. Displays 14 may, for example, include organic light-emitting diode pixels formed on substrates with thin-film circuitry and/or formed on semiconductor substrates, pixels formed from crystalline semiconductor dies, liquid crystal display pixels, scanning display devices, and/or other display devices for producing images.

Lenses 30, which may sometimes be referred to as fixed lenses, may include one or more lens elements and may be used in conjunction with respective overlapping vision correction lenses 52 to provide image light from displays 14 to respective eyes boxes 13. Lenses for device 10 (e.g., lenses 30) may be implemented using refractive lens elements, using one or more adjustable lenses such as a fluid-filled lens, an Alvarez lens, a liquid crystal lens, and/or any other adjustable lens, using mirror lens structures (catadioptric lenses), using Fresnel lenses, using holographic lenses, and/or other lens systems. Removable lenses 52 may likewise be formed from such lens elements (e.g., refractive lens elements).

When a user's eyes are located in eye boxes 13, displays (display panels) 14 operate together to form a display for device 10 (e.g., the images provided by respective left and right optical modules 40 may be viewed by the user's eyes in eye boxes 13 so that a stereoscopic image is created for the user). The left image from the left optical module fuses with the right image from a right optical module while the display is viewed by the user.

It may be desirable to monitor the user's eyes while the user's eyes are located in eye boxes 13. For example, it may be desirable to use a camera to capture images of the user's irises (or other portions of the user's eyes) for user authentication. It may also be desirable to monitor the direction of the user's gaze. Gaze tracking information may be used as a form of user input and/or may be used to determine where, within an image, image content resolution should be locally enhanced in a foveated imaging system. To ensure that device 10 can capture satisfactory eye images while a user's eyes are located in eye boxes 13, each optical module 40 may be provided with a camera such as camera 42 and one or more light sources such as light sources 44 (e.g., light-emitting diodes, lasers, etc.).

Cameras 42 and light sources 44 may operate at any suitable wavelengths (visible, infrared, and/or ultraviolet). With an illustrative configuration, which may sometimes be described herein as an example, light sources 44 emit infrared light that is invisible (or nearly invisible) to the user. The emitted light may, as an example, be near infrared light at a wavelength of 740 nm to 1000 nm, 940 nm, 850 nm to 1000 nm, or other suitable near infrared wavelength. This allows eye monitoring operations to be performed continuously without interfering with the user's ability to view images on displays 14. Light sources 44 may, for example, include multiple light-emitting diodes or lasers arranged in a ring around the periphery of support structure 32. During operation, emitted infrared light from light sources 44 may pass through lenses 30 and 52 to illuminate the user's eyes (e.g., as flood illumination and/or glints) and cameras 42 may capture infrared images of the user's illuminated eyes through lenses 30 and 52.

Not all users have the same interpupillary distance. To provide device 10 with the ability to adjust the interpupillary spacing between modules 40 along lateral dimension X and thereby adjust the spacing between left and right eye boxes 13 to accommodate different user interpupillary distances, device 10 may be provided with actuators 43 (e.g., left and right actuators or a common actuator that adjusts the position of both left and right optical modules). Actuators 43 can be manually controlled and/or actuators 43 may be computer-controlled actuators (e.g., computer-controlled motors) that are used to move support structures 32 relative to each other. Information on the locations of the user's eyes may be gathered using, for example, cameras 42. The locations of eye boxes 13 can then be adjusted accordingly.

Device 10 of FIG. 1 may be operated as a stand-alone device and/or the resources of device 10 may be used to communicate with external electronic equipment. As an example, communications circuitry in device 10 may be used to receive user input information from an external controller and may be used to receive video and/or audio content from external equipment.

To reduce the amount of prescription lenses needed on hand at a demonstration site (e.g., a retail store, conference, exposition, channel sale setting, etc.), the demonstration site may be provided with a system of multiple head-mounted devices having different virtual image distances. The virtual image distance of a head-mounted device is based on the distance between the display such as display 14 and the lens such as lens 30 (e.g., the lens that is fixed within housing 12 of device 10). Changing the virtual image distance (e.g., the distance between fixed lens 30 and display 14) is equivalent to a spherical prescription correction. By combining a head-mounted display unit 10 with an offset virtual image distance with a clip-on or otherwise modular prescription lens, a user's individual prescription may be accommodated without requiring the supplemental prescription lens 52 to exactly match the user's prescription. As such, a fewer number of prescription lenses may be kept on hand in a demonstration site by keeping in stock multiple head-mounted display units with different virtual image distances.

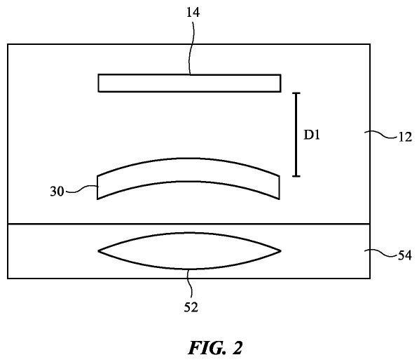

FIG. 2 is a top view of an illustrative head-mounted device 10 with a first virtual image distance. As shown in FIG. 2, head-mounted device 10 may include display 14 and lens 30 separated by distance D1. Device 10 with virtual image distance D1 may be a nominal baseline unit that provides zero spherical correction. Device 10 of FIG. 2 may be used with or without a supplemental modular lens such as prescription lens 52. If, for example, a user at a demonstration site does not require any prescription correction, then the user may be provided with a baseline unit of the type shown in FIG. 2 without any supplemental lens 52. When used without a supplemental modular prescription lens, baseline unit 10 of FIG. 2 may allow the user to view images on display 14 through lens 30 without any prescription correction to the displayed images.

If, on the other hand, the user does have a prescription, the user may be able to attach a supplemental modular prescription lens such as lens 52 to device 10. Lens 52 may accommodate the user's prescription such that the user can clearly view images on display 14 through lens 52 and lens 30 without eye strain.

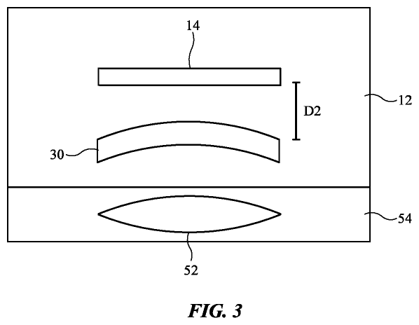

FIG. 3 is a top view of an illustrative head-mounted device 10 with a second virtual image distance. As shown in FIG. 3, head-mounted device 10 may include display 14 and lens 30 separated by distance D2. Device 10 with virtual image distance D2 may be a myopic unit that provides spherical correction to accommodate myopic users and/or users with presbyopia. Device 10 of FIG. 3 may be used with or without a supplemental modular lens such as prescription lens 52. If, for example, a user at a demonstration site is nearsighted but does not require any additional prescription correction, then the user may be provided with a myopic unit of the type shown in FIG. 3 without any supplemental lens 52. When used without a supplemental modular prescription lens, myopic unit 10 of FIG. 3 may allow the user to view images on display 14 through lens 30 with images appearing slightly closer to the viewer due to the reduced virtual image distance D2. This helps accommodate nearsighted viewers without requiring any additional prescription lens to be attached to device 10.

If, on the other hand, the user does have a prescription, the user may be able to attach a supplemental modular prescription lens such as lens 52 to device 10. Lens 52 may accommodate the user's prescription such that the user can clearly view images on display 14 through lens 52 and lens 30 without eye strain.

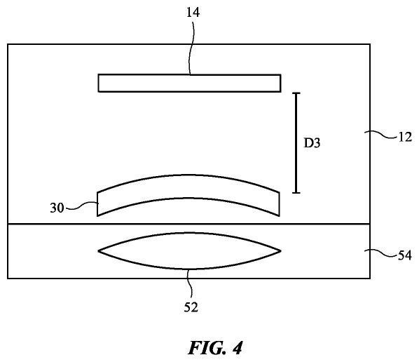

FIG. 4 is a top view of an illustrative head-mounted device 10 with a second virtual image distance. As shown in FIG. 4, head-mounted device 10 may include display 14 and lens 30 separated by distance D3. Device 10 with virtual image distance D3 may be a hyperopic unit that provides spherical correction to accommodate farsighted users. Device 10 of FIG. 4 may be used with or without a supplemental modular lens such as prescription lens 52. If, for example, a user at a demonstration site is farsighted but does not require any additional prescription correction, then the user may be provided with a hyperopic unit of the type shown in FIG. 4 without any supplemental lens 52. When used without a supplemental modular prescription lens, baseline unit 10 of FIG. 4 may allow the user to view images on display 14 through lens 30 with images appearing slightly farther from the viewer due to the increased virtual image distance D3. This helps accommodate farsighted viewers without requiring any additional prescription lens to be attached to device 10.

If, on the other hand, the user does have a prescription, the user may be able to attach a supplemental modular prescription lens such as lens 52 to device 10. Lens 52 may accommodate the user's prescription such that the user can clearly view images on display 14 through lens 52 and lens 30 without eye strain.

The use of three units with three different virtual image distances is merely illustrative. If desired, a demonstration site may carry head-mounted devices 10 with four, five, six, less than six, or more than six different virtual image distances. In other arrangements, device 10 may have an adjustable virtual image distance. For example, the distance between display 14 and lens 30 may be electrically and/or manually adjustable, thereby allowing a user and/or a salesperson to adjust the virtual image distance to the appropriate location based on the user's prescription and/or based on the supplemental prescription lenses 52 available to attach to device 10. The distance between display 14 and lens 30 may be continuously adjustable between first and second distances (e.g., a minimum and a maximum distance), or may be discretely adjustable to certain fixed distances such as D1, D2, D3, etc. Arrangements in which the virtual image distance is not adjustable but instead is fixed at different distances depending on the unit are sometimes described herein as an illustrative example.

The availability of head-mounted display units with different virtual image distances, when combined with a given number of modular prescription lenses 52, helps accommodate a much greater number of prescriptions (e.g., a number greater than the amount of prescription lenses on hand at the store). This allows the retail environment to give demonstrations to a larger percentage of the population while requiring a lower number of supplemental prescription lenses to be kept in stock.

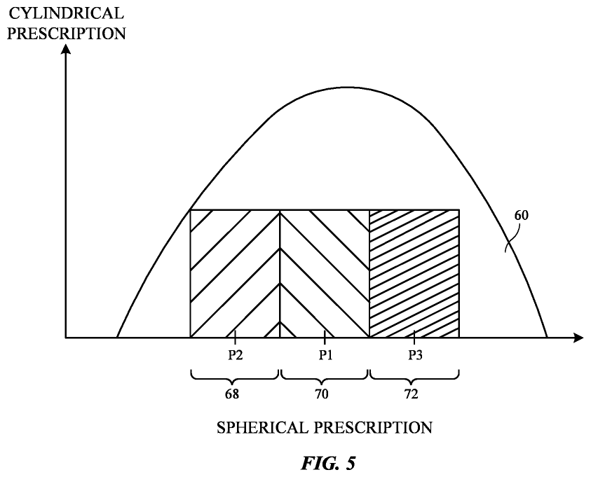

FIG. 5 is a graph showing how a larger percentage of a population with different prescriptions may be accommodated by devices 10 with different virtual image distances and optional modular prescription lenses. Bounded region 60 of FIG. 5 represents the range of prescriptions associated with a given population of users (e.g., users in a given country, a given region, a given city, a given store, etc.). Point P1 represents the prescription correction of a nominal baseline unit with virtual image distance D1 (e.g., such as unit 10 of FIG. 2) that does not include any supplemental modular prescription lens attached. P1 may be, for example, zero diopters of spherical correction and zero diopters of cylindrical prescription.

Region 70 represents the range of prescription corrections that can be accommodated by a nominal baseline unit such as device 10 of FIG. 2 and a given number of prescription lenses 52. As shown in FIG. 5, region 70 includes spherical corrections (e.g., ranging from −2.5 diopters to 2.5 diopters, from −3 diopters to 3 diopters, and/or any other suitable range of spherical corrections) as well as cylindrical corrections (e.g., ranging from 0 diopters to −6 diopters, from 0 diopters to −4 diopters, and/or any other suitable range of cylindrical corrections).

Point P2 represents the prescription correction of a myopic unit with virtual image distance D2 (e.g., such as unit 10 of FIG. 3) that does not include any supplemental modular prescription lens attached. P2 may be, for example, −5 diopters of spherical correction (or −3 diopters, −2 diopters, −4 diopters, −6 diopters, etc.) and zero diopters of cylindrical prescription. Region 68 represents the range of prescription corrections that can be accommodated by a myopic unit such as device 10 of FIG. 3 and a given number of prescription lenses 52. As shown in FIG. 5, region 68 includes spherical corrections (e.g., ranging from −8 diopters to −2 diopters, from −7 diopters to −3 diopters, and/or any other suitable range of spherical corrections) as well as cylindrical corrections (e.g., ranging from 0 diopters to −6 diopters, from 0 diopters to −4 diopters, and/or any other suitable range of cylindrical corrections).

Point P3 represents the prescription correction of a hyperopic unit with virtual image distance D3 (e.g., such as unit 10 of FIG. 4) that does not include any supplemental modular prescription lens attached. P3 may be, for example, 5 diopters of spherical correction (or 3 diopters, 2 diopters, 4 diopters, 6 diopters, etc.) and zero diopters of cylindrical prescription. Region 72 represents the range of prescription corrections that can be accommodated by a myopic unit such as device 10 of FIG. 4 and a given number of prescription lenses 52. As shown in FIG. 5, region 72 includes spherical corrections (e.g., ranging from 2 diopters to 8 diopters, from 3 diopters to 7 diopters, and/or any other suitable range of spherical corrections) as well as cylindrical corrections (e.g., ranging from 0 diopters to −6 diopters, from 0 diopters to −4 diopters, and/or any other suitable range of cylindrical corrections).

In addition to or instead of changing the distance between display 14 and fixed lens 30 to change the virtual image distance, the virtual image distance may be adjusted by modifying the fixed optical system in device 10 (e.g., lens 30 and/or other fixed lens within device 10). With this type of arrangement, head-mounted device 10 may include an optical system that is specifically made for myopic users or hyperopic users without needing to change the distance between display 14 and lens 30. For example, a nominal unit 10, a myopic unit 10, and a hyperopic unit 10 may have the same distance between display 14 and lens 30, but may have different optical systems (e.g., different fixed lenses 30) to accommodate users with different prescriptions. In particular, a fixed lens in device 10 such as lens 30 and/or an additional fixed lens in device 10 may provide some spherical correction to images on display 14 (e.g., lens 30 may have a negative optical power in a myopic unit, a positive optical power in a hyperopic unit 10, and zero optical power in a nominal unit). By adjusting the optical power of lens 30 (in addition to or instead of adjusting the distance between display 14 and lens 30) and having a given number of modular prescription lenses 52 on hand, a greater population of users can be accommodated with a fewer number of modular prescription lenses 52. In some arrangements, lens 30 may be a tunable lens with an adjustable optical power so that a single unit 10 can accommodate myopic and hyperopic users. In other arrangements, lens 30 may not be adjustable but instead may be set to different optical powers in different units 10.

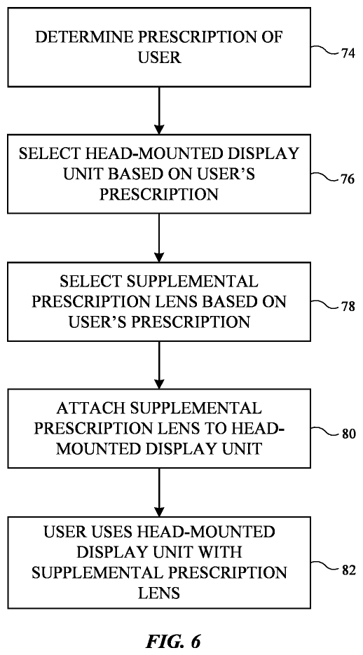

FIG. 6 is a flow chart of illustrative steps involved in providing a user with the appropriate head-mounted device in a demonstration setting.

During the operations of block 74, the prescription of the user may be determined. This may be achieved using head-mounted device 10 itself, using an external electronic device, and/or by receiving the prescription information from the user. If desired, control circuitry in device 10 and/or in another electronic device may be configured to determine a user's prescription and accommodation range during a vision characterization process. The vision characterization process may include adjusting the optical power of an adjustable lens until the user indicates that an object viewed through the adjustable lens is in focus. A distance sensor may measure the distance to the in-focus object. The control circuitry may calculate the user's prescription based on the optical power of the lens and the distance to the in-focus object. During vision characterization operations, control circuitry may adjust the optical power of the lens automatically or in response to user input. The adjustable lens may be part of device 10, part of another electronic device, and/or a standalone eyepiece.

During the operations of block 76, a head-mounted display unit may be selected based on the user's prescription. If a user does not require any prescription correction or has a prescription within region 70, the baseline unit with a nominal virtual image distance may be selected. If the user is nearsighted or has a prescription within region 68, the myopic unit with a decreased virtual image distance may be selected. If the user is farsighted or has a prescription within region 72, the hyperopic unit may be selected. In some arrangements, the selected unit 10 may be one with an offset distance between display 14 and lens 30 (e.g., unit 10 of FIG. 3 or unit 10 of FIG. 4). In other arrangements, the selected unit 10 may have a nominal or baseline distance between display 14 and lens 30 (e.g., as in the example of FIG. 2) but may have an offset virtual image distance that is achieved using an optical system in device 10 such as using a fixed lens 30 with a nonzero spherical optical power (e.g., a positive spherical power for hyperopic users or a negative spherical power for myopic users).

During the operations of optional block 78, a supplemental prescription lens 52 may be selected based on the user's prescription. This may include, for example, selecting a given lens 52 with an appropriate cylindrical correction, spherical correction, astigmatism correction, and/or any other suitable prescription correction that, when combined with the spherical correction of device 10 (if any), will allow the user to clearly see images on device 10 without eye strain.

During the operations of block 80, the supplemental prescription lens 52 selected during the operations of block 78 may be attached to the head-mounted device 10 selected during the operations of block 76. This may include using one or more magnets 56 or other attachment structures (e.g., press-fit connections, clips, fasteners, etc.) to attach vision correction lens 52 to module 40.

During the operations of block 82, the user may try on the head-mounted device 10 (e.g., a nominal baseline unit, a myopic unit, a hyperopic unit, or other suitable unit) with the attached prescription lens 52. If the user wishes to purchase a given device, the user may purchase a nominal unit (e.g., with a baseline virtual image distance that does not provide any spherical correction) and may order a prescription lens 52 that accommodates the user's precise prescription. This allows the user to try on and test out the device at a demonstration site even if the demonstration site does not have the precise prescription lens 52 that the user needs.

If desired, the virtual image distances of the head-mounted device units in a given store may be optimized based on regional and/or store-specific data (e.g., more myopic units for countries with more myopic users, not requiring a unit for presbyopia if store traffic patterns show a larger percentage of customers are under the age of 40, etc.).

In accordance with an embodiment, a head-mounted device is provided that includes a support structure, a display coupled to the support structure and configured to display an image, a lens through which the display is visible from an eye box, the display and the lens are separated by a distance that imparts a spherical correction to the image and a supplemental prescription lens that imparts a cylindrical correction to the image.

In accordance with another embodiment, the supplemental prescription lens is removably attached to the support structure using clips.

In accordance with another embodiment, the spherical correction is configured to accommodate a myopic population of users.

In accordance with another embodiment, the spherical correction is configured to accommodate a hyperopic population of users.

In accordance with another embodiment, the distance between the lens and the display is adjustable.

In accordance with another embodiment, the distance between the lens and the display is a first distance when accommodating myopic vision and a second distance when accommodating hyperopic vision and the first distance is less than the second distance.

In accordance with another embodiment, a combination of the spherical correction and the cylindrical correction is configured to provide a given prescription correction to the image, the given prescription correction is based on a user's actual prescription.

In accordance with another embodiment, the spherical correction has a negative optical power to accommodate a myopic population.

In accordance with another embodiment, the spherical correction and the cylindrical correction combine to form a prescription that accommodates presbyopia.

In accordance with another embodiment, the spherical correction has a positive optical power to accommodate a hyperopic population.

In accordance with an embodiment, a head-mounted device is provided that includes a support structure, a display coupled to the support structure and configured to display an image, a first lens that is permanently attached to the support structure and that provides a virtual image distance that accommodates a population selected from the group consisting of: a myopic population and a hyperopic population and a second lens that is removably attached to the support structure, the display is visible from an eye box through the first and second lenses and the first and second lenses are configured to provide a combined prescription correction.

In accordance with another embodiment, the virtual image distance is adjustable.

In accordance with another embodiment, the head-mounted device includes clips that are configured to removably attach the second lens to the support structure.

In accordance with another embodiment, the second lens is one of multiple prescription lenses configured to be removably attached to the support structure and the multiple prescription lenses accommodate at least some of the myopic population and the hyperopic population.

In accordance with another embodiment, the first lens has a nonzero spherical power.

In accordance with an embodiment, a method is provided that includes determining a vision prescription of a user, based on the vision prescription, selecting a head-mounted display unit from a group of head-mounted display units with different virtual image distances and based on the vision prescription, selecting a supplemental prescription lens from a group of supplemental prescription lenses with different prescriptions and attaching the selected supplemental prescription lens to the selected head-mounted display unit, the selected head-mounted display unit and the selected supplemental prescription lens form a combined prescription that matches the vision prescription.

In accordance with another embodiment, the group of head-mounted display units includes a first head-mounted display unit having a first virtual image distance, a second head-mounted display unit having a second virtual image distance, and a third head-mounted display unit having a third virtual image distance, and the first, second, and third virtual image distances are different.

In accordance with another embodiment, the first head-mounted display unit is configured to accommodate myopic vision and the second head-mounted display unit is configured to accommodate hyperopic vision.

In accordance with another embodiment, the first virtual image distance is less than the second virtual image distance.

In accordance with another embodiment, the third virtual image distance is greater than the first virtual image distance and less than the second virtual image distance.

The foregoing is merely illustrative and various modifications can be made to the described embodiments. The foregoing embodiments may be implemented individually or in any combination.

What is claimed is:

1. A head-mounted device, comprising:
a support structure;
a display coupled to the support structure and configured to display an image;
a lens through which the display is visible from an eye box, wherein the display and the lens are separated by a distance that imparts a spherical correction to the image; and
a supplemental prescription lens that imparts a cylindrical correction to the image.

2. The head-mounted device defined in claim 1 wherein the supplemental prescription lens is removably attached to the support structure using clips.

3. The head-mounted device defined in claim 1 wherein the spherical correction is configured to accommodate a myopic population of users.

4. The head-mounted device defined in claim 1 wherein the spherical correction is configured to accommodate a hyperopic population of users.

5. The head-mounted device defined in claim 1 wherein the distance between the lens and the display is adjustable.

6. The head-mounted device defined in claim 5 wherein the distance between the lens and the display is a first distance when accommodating myopic vision and a second distance when accommodating hyperopic vision and wherein the first distance is less than the second distance.

7. The head-mounted device defined in claim 1 wherein a combination of the spherical correction and the cylindrical correction is configured to provide a given prescription correction to the image, wherein the given prescription correction is based on a user's actual prescription.

8. The head-mounted device defined in claim 1 wherein the spherical correction has a negative optical power to accommodate a myopic population.

9. The head-mounted device defined in claim 8 wherein the spherical correction and the cylindrical correction combine to form a prescription that accommodates presbyopia.

10. The head-mounted device defined in claim 1 wherein the spherical correction has a positive optical power to accommodate a hyperopic population.

11. A head-mounted device, comprising:
a support structure;
a display coupled to the support structure and configured to display an image;
a first lens that is permanently attached to the support structure and that provides a virtual image distance that accommodates a population selected from the group consisting of: a myopic population and a hyperopic population; and
a second lens that is removably attached to the support structure, wherein the display is visible from an eye box through the first and second lenses and wherein the first and second lenses are configured to provide a combined prescription correction.

12. The head-mounted device defined in claim 11 wherein the virtual image distance is adjustable.

13. The head-mounted device defined in claim 11 further comprising clips that are configured to removably attach the second lens to the support structure.

14. The head-mounted device defined in claim 11 wherein the second lens is one of multiple prescription lenses configured to be removably attached to the support structure and wherein the multiple prescription lenses accommodate at least some of the myopic population and the hyperopic population.

15. The head-mounted device defined in claim 11 wherein the first lens has a nonzero spherical power.

16. A method, comprising:
determining a vision prescription of a user;
based on the vision prescription, selecting a head-mounted display unit from a group of head-mounted display units with different virtual image distances; and
based on the vision prescription, selecting a supplemental prescription lens from a group of supplemental prescription lenses with different prescriptions; and
attaching the selected supplemental prescription lens to the selected head-mounted display unit, wherein the selected head-mounted display unit and the selected supplemental prescription lens form a combined prescription that matches the vision prescription.

17. The method defined in claim 16 wherein the group of head-mounted display units comprises a first head-mounted display unit having a first virtual image distance, a second head-mounted display unit having a second virtual image distance, and a third head-mounted display unit having a third virtual image distance, and wherein the first, second, and third virtual image distances are different.

18. The method defined in claim 17 wherein the first head-mounted display unit is configured to accommodate myopic vision and the second head-mounted display unit is configured to accommodate hyperopic vision.

19. The method defined in claim 18 wherein the first virtual image distance is less than the second virtual image distance.

20. The method defined in claim 19 wherein the third virtual image distance is greater than the first virtual image distance and less than the second virtual image distance.
